(19) United States
(12) Patent Application Publication
(10) Pub. No.: US 2026/0279704 A1
(43) Pub. Date: Sep. 17, 2026

(54) EARTH SWITCHING DEVICE

(71) Applicant: HYOSUNG HEAVY INDUSTRIES CORPORATION, Seoul (KR)

(72) Inventors: Kwang Joong LEE, Changwon-si, Gyeongsangnam-do (KR); Kyoung Kyu LEE, Changwon-si, Gyeongsangnam-do (KR); Kyeng Min HAN, Changwon-si, Gyeongsangnam-do (KR)

(21) Appl. No.: 18/878,090

(22) PCT Filed: Nov. 8, 2023
(86) PCT No.: PCT/KR2023/017848

§ 371 Date: Dec. 23, 2024

(30) Foreign Application Priority Data
Nov. 11, 2022 (KR) 10-2022-0150214

(51) Int. Cl. H01H 33/22; H01H 1/38; H01H 31/00; H01H 33/12

(52) U.S. Cl. CPC H01H 33/22; H01H 1/38; H01H 31/003; H01H 33/12

(57) ABSTRACT

The present disclosure relates to an earth switching device having an arc inducing part provided inside a fixed part, so as to induce an arc generated at a moving contact toward the arc inducing part when the moving contact and the fixed contact become close to or away from each other, thereby preventing damage to the fixed contact caused by the arc.

### TECHNICAL FIELD

The present disclosure relates to an earth switching device, and more particularly, to an earth switching device in which an arc inducing part is provided in a fixed part for inducing an arc generated at a moving contact toward the arc inducing part when the moving contact and a fixed contact are approached or separated from each other, thereby preventing damage to the fixed contact.

### BACKGROUND ART

In general, a gas insulated switchgear (GIS) is installed on an electric line for indoor, outdoor power plant, and substation to artificially open and close a load current under normal use. In addition, when an abnormal current such as an accident or a short circuit occurs, the current is safely blocked to protect the power system and the power device.

The gas insulated switchgear consist of opening/closing facilities such as a circuit breaker (CB), a disconnector (DS), a current transformer (CT), an earth switch (ES), and a bus in a metal tank filled with an inert gas.

The earth switching device is divided into two types. One is an apparatus earth switch installed between a circuit breaker and a disconnector, and on a bus to perform an earthing function for the circuit during maintenance of the circuit breaker, disconnector, and bus, thereby ensuring the safety of workers. The other is a track earth switch installed on a track side of an ultra-high voltage transmission line and performs an input function for a fault current in addition to the earthing function such as the apparatus earth switch.

The earth switching device is provided inside the gas insulated switchgear and serves to prevent a safety accident by earthing a main circuit for safety during abnormal voltage generation, accident, or other repair inspections.

The earth switching device is configured to include a moving part that moves back and forth through the operation of a manipulator, a moving contact that contacts the moving part in an open state, a fixed contact that contacts or leaves based on the reciprocating motion of the moving part, and a connection bar that conducts electricity to a ground side in an input(close) state.

In the earth switch. when the manipulator operates according to an input signal in the open state, the moving part connected to the manipulator slides to be put into the fixed contact.

The direction of the current is conducted to the ground side by sequentially passing through the fixed contact, the moving part, the moving contact, and the connection bar.

Conversely, in the blocking operation, when the manipulator operates according to the open signal in the input state, the moving part slides in the opposite direction to be separated from the fixed contact and to block the flow of the current.

When the moving contact and the fixed contact of the earth switching device become closer to or away from each other, an arc may be generated.

That is, the arc mainly forms at the contact point between the moving contact of the moving part and the fixed contact of the fixed part at the beginning of arc occurrence. However, as the arc persists, the heat from the arc spreads to the contact points (both the moving and fixed contacts) that transmit current to the main circuit, causing the contacts to erode.

In order to solve these problems, an earth switch having an arc inducing part (free arc contact point) inside a stator is disclosed in Korean Utility Model Registration No. 20-0411499.

In the conventional earth switch, a free arc contact point corresponding to a moving contact of a moving part is formed in a vertical direction at a central portion of a finger forming a fixed part, and a coupling groove into which the free arc contact point is inserted and coupled to a lower side of the moving contact is formed to a predetermined depth, and an incision groove is formed in an upper portion of the free arc contact point to be elastically inserted into the coupling groove.

However, in the case of an earth switch including a conventional free arc contact point, since a free arc contact point is disposed on the same line as a fixed contact, a free arc irregularly generated may be generated at fixed contact as well as the free arc contact point, and thus, the fixed contact may be damaged.

In addition, since the conventional earth switching device has a structure in which the free arc contact point is inserted into a communication hole of the mover, the freedom of design of the free arc contact is limited.

In addition, as the free arc contact point is formed to be smaller than the moving contact, the free arc inducing performance is degraded.

### DETAILED DESCRIPTION OF THE DISCLOSURE

### Technical Problem

Therefore, the purpose of the present disclosure is to solve the problems of the prior art as described above and provide an earth switching device in which an arc inducing part is provided in a fixed part to induce an arc generated at a moving contact toward the arc inducing part when the moving contact and a fixed contact become close to or away from each other, thereby preventing damage to the fixed contact.

### Technical Solution

According to the features of the present disclosure for achieving the above purpose, an earth switching device comprises: a housing; a moving part provided inside the housing to be reciprocated by a manipulator and having a moving contact at an end thereof; a fixed part disposed to be spaced apart from the moving part by a predetermined distance, and having a fixed contact selectively grounded or short-circuited with the moving contact according to the reciprocating motion of the moving part ; and an arc inducing part provided to be able to move up and down inside the fixed contact, and inducing an arc generated at the moving contact when the moving contact approaches or moves away from the fixed contact.

The arc inducing part comprises: an arc inducing body provided inside the fixed part and having an elastic member mounting groove formed on the upper surface thereof and a lifting bar guide groove formed on the lower surface thereof; a lifting bar provided inside the arc inducing body and disposed to be vertically movable along the lifting guide groove; an arc inducing head fixedly disposed at an end of the lifting bar and made of a conductive material to induce an arc when the moving contact is adjacent; and an elastic member made of an elastic body, provided inside the elastic member mounting groove, and one end is in close contact with one side of the arc inducing head to elastically support the arc inducing head.

The arc inducing head may be disposed to protrude further upward than the fixed contact.

The moving part may further include a fluid receiving part formed as an empty space and be filled with a fluid therein.

One side of the fluid receiving part includes a fluid injecting hole formed vertically through the moving part. One end of the fluid injecting hole communicates with the fluid receiving part, and the other end communicates with the outside to spray the fluid to the arc inducing part.

The fluid filled in the fluid receiving part may be sprayed to the arc inducing part when the fixed contact and the moving contact are away from each other.

The fluid may consist of an insulating gas and may be sprayed onto a lower portion of the moving contact to suppress the generation of an arc.

### Advantageous Effects

An earth switching device according to the present disclosure has the following effects.

In the earth switching device of the present disclosure, an arc inducing part is provided in a fixed part to induce an arc generated at a moving contact toward the arc inducing part when the moving contact and a fixed contact become close to or away from each other, thereby preventing damage to the fixed contact by the arc.

In addition, an arc inducing head of the arc inducing part is provided inside the fixed part to be movable up and down. Accordingly, even after the moving contact is short-circuited with the fixed contact, the contact between the moving contact and the arc inducing head is maintained to minimize the arc generated toward the fixed contact.

In addition, after the moving contact and the arc inducing part are short-circuited, a fluid consisting of an insulating gas is sprayed toward the arc inducing part to suppress the generation of the arc, thereby preventing damage to the moving contact by the arc.

### BRIEF DESCRIPTION OF THE DRAWINGS

FIG. 1 is a front view and a cross-sectional view illustrating a configuration of an earth switching device according to a preferred embodiment of the present disclosure.

FIG. 2 is a cross-sectional view illustrating a configuration of a moving part and a fixed part constituting the embodiment of the present disclosure.

FIG. 3 is a cross-sectional view illustrating a state in which a moving contact and a fixed contact constituting the embodiment of the present disclosure are grounded.

FIG. 4 is a cross-sectional view illustrating a state in which the moving contact and the fixed contact constituting the embodiment of the present disclosure are short-circuited.

FIG. 5 is a cross-sectional view illustrating a fluid state in which the moving contact constituting the embodiment of the present disclosure is short-circuited at the fixed contact.

### BEST MODE FOR DISCLOSURE

Hereinafter, some embodiments of the present disclosure will be described in detail with reference to the accompanying drawings. In addition to reference numerals in the elements of each drawing, it should be noted that the same reference numerals are used for the same elements although they have the same reference numerals. Further, in the following description of the embodiments of the present invention, a detailed description of known functions and configurations incorporated herein will be omitted when it is determined that the detailed description thereof interferes with the understanding of the embodiments of the present disclosure.

In addition, terms, such as first, second, A, B, (a), (b), and the like may be used herein when describing components. These terms are only used to distinguish the components from other components, and the nature or order or order of the corresponding components is not limited by the terms. It should be understood that when one component is referred to as being “connected”, “coupled” or “joined” to another component, the former may be directly connected or coupled to the other component, but another component may be “connected”, “coupled”, or “joined” between the first and second components.

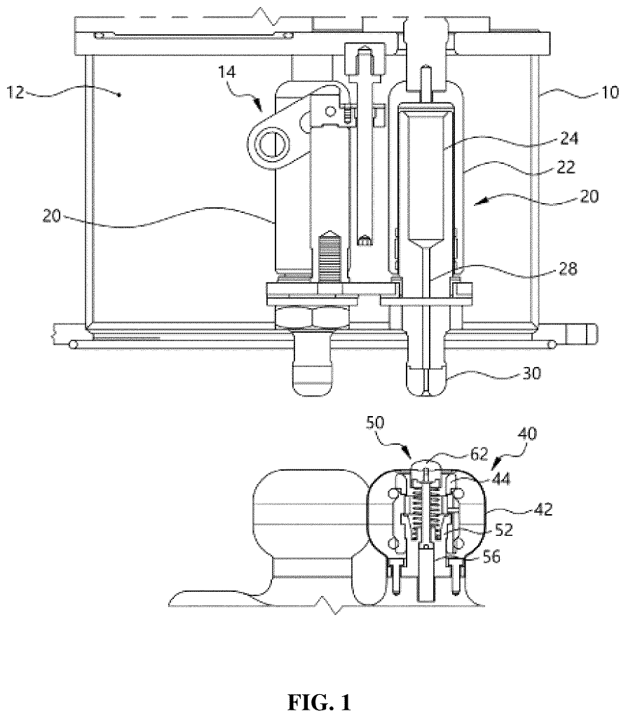

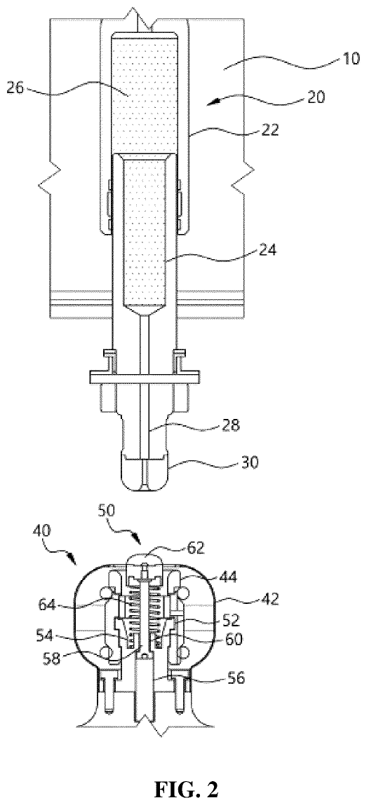

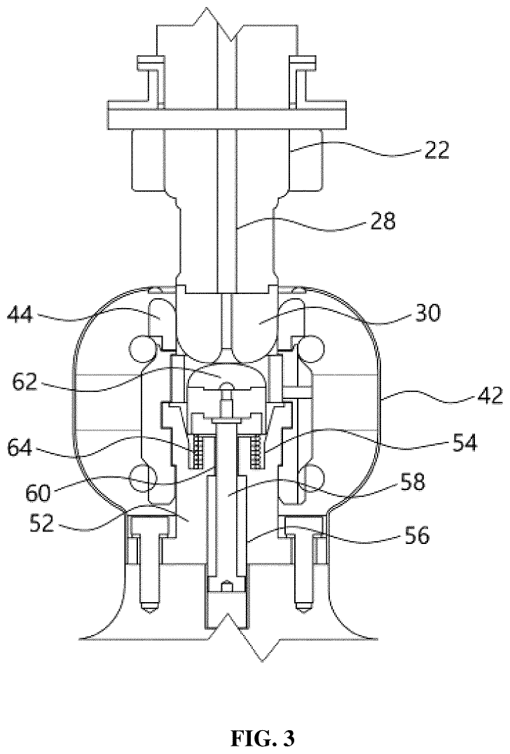

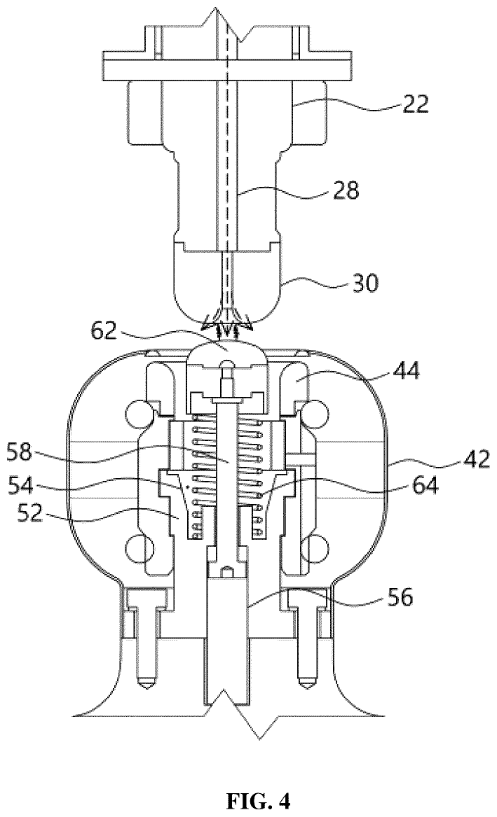

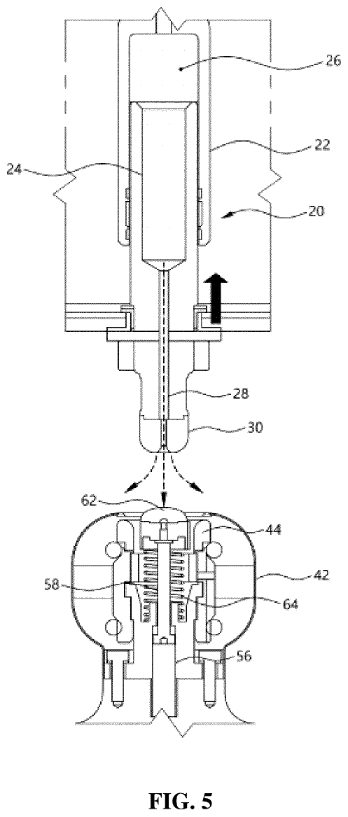

FIG. 1 is a front view and a cross-sectional view illustrating a configuration of an earth switching device according to a preferred embodiment, FIG. 2 is a cross-sectional view illustrating a configuration of a moving part and a fixed part constituting the embodiment of the present disclosure, FIG. 3 is a cross-sectional view illustrating a state in which a moving contact and a fixed contact are grounded, FIG. 4 is a cross-sectional view illustrating a state in which the moving contact and the fixed contact are short-circuited, and FIG. 5 is a cross-sectional view illustrating a fluid state in which the moving contact is short-circuited at the fixed contact.

As shown in these figures, the earth switching device comprises: a housing (10); a moving part (20) provided inside the housing (10) to be reciprocated by a manipulator and having a moving contact (30) at an end thereof; a fixed part (40) disposed to be spaced apart from the moving part (20) by a predetermined distance, and having a fixed contact (44) selectively grounded or short-circuited with the moving contact (30) according to the reciprocating motion of the moving part (20); and an arc inducing part (50) provided to be able to move up and down inside the fixed contact (44), and inducing an arc generated at the moving contact (30) when the moving contact (30) approaches or moves away from the fixed contact (44).

The housing (10) is formed in a chamber shape to form an outer appearance, and an inner space (12) is formed in the housing (10). A manipulator (14) and a moving part (20) are disposed in the inner space (12). The manipulator (14) is an operator of a general earth switching device, and thus a detailed description thereof will be omitted. The manipulator (14) is fixedly disposed at one side of the moving part (20) to allow the moving part (20) to reciprocate upward and downward.

As shown in FIG. 2, the moving part (20) includes a moving body part (22), a fluid receiving part (24), and a moving contact (30).

The moving body part (22) is formed in a cylindrical shape and is formed long in a vertical direction. The moving body part (22) is disposed inside the housing (10) and moves up and down according to the operation of the manipulator (14).

In addition, according to the vertical movement of the moving body part (22), grounding and short-circuiting operations between a moving contact (30) and a fixed contact (44), which will be described later, may be performed.

A fluid receiving part (24) is formed in the moving body part (22). The fluid receiving part (24) is formed as an empty space having a cylindrical shape inside the moving body part (22). A fluid (26), which will be described later, is filled in the fluid receiving part (24).

The fluid (26) is a general insulating gas, and thus a detailed description thereof will be omitted. The fluid (26) is sprayed onto the lower portion of the moving part (20) through a piston injection method in a state in which the fluid (26) is filled in the fluid receiving part (24). The fluid (26) is formed of an insulating gas and is sprayed in a lower direction of the moving part (20) to suppress generation of an arc.

A fluid injection hole (28) is formed at a lower portion of the fluid receiving part (24). The fluid injection hole (28) is vertically formed through the center of the moving body part (22). One end of the fluid injection hole (28) communicates with the fluid receiving part (24), and the other end of the fluid injection hole (28) communicates with the outside of the moving part (20).

The fluid injection hole (28) communicates with the fluid receiving part (24), and serves as a path for guiding the fluid (26) to be sprayed in the lower direction of the moving part (20) during the injection operation of the fluid (26).

A moving contact (30) is provided on a lower surface of the moving body part (22). The moving contact (30) has a cylindrical shape and is fixedly provided on a lower surface of the moving body part (22). A detailed description of the moving contact (30) will be omitted. The moving contact (30) is selectively brought into contact with a fixed contact (44), which will be described later, according to the vertical movement of the moving body part (22), and serves to conduct electricity in a ground operation.

A fixed part (40) is provided at a lower portion of the moving part (20). As shown in FIG. 3, the fixed part (40) includes a fixed shield part (42), a fixed contact (44), and an arc inducing part (50).

The fixed shield part (42) is formed in a cylindrical shape having an approximately hollow interior, and a plurality of components are installed inside the fixed shield part (42). A plurality of components are installed in the fixed shield part (42) to be protected.

The fixed contact (44) is provided in the fixed shield part (42). The fixed contact (44) is a general fixed contact, and thus a detailed description thereof will be omitted. The fixed contact (44) is made of a conductive material and is formed in a circular ring shape. The fixed contact is disposed at an inner upper end of the fixed shield part (42), and the moving contact (30) is received therein to be grounded and conducted.

An arc inducing part (50) is provided inside the fixed contact (44). The arc inducing part (50) includes an arc inducing body (52), a lifting bar (58), an arc inducing head (62), an elastic member (64), and the like.

The arc inducing body (52) has a cylindrical shape and is provided inside the fixed shield part (42). The arc inducing body (52) is provided inside the fixed shield part (42) to guide vertical movement of a lifting bar (58) to be described later and to support an elastic member (64) to be described later.

An elastic member mounting groove (54) is formed on an upper surface of the arc inducing body (52). The elastic member mounting groove (54) is recessed by a predetermined depth to receive a portion of the elastic member (64), which will be described later.

A lifting bar guide groove (56) is formed on a lower surface of the arc inducing body (52). The lifting bar guide groove (56) is formed in a cylindrical shape at the center of the bottom surface of the arc inducing body (52) and is recessed by a predetermined depth. A portion of a lifting bar (58), which will be described later, is disposed in the lifting bar guide groove (56), so that the vertical movement of the lifting bar (58) is guided.

A lifting bar (58) is provided in the lifting bar guide groove (56). The lifting bar (58) is formed in a bar shape, and is formed long in a vertical direction. A portion of the lifting bar (58) is disposed in the lifting bar guide groove (56). In addition, the rest of the lifting bar (58) protrudes upward from the arc inducing body (52) through a lifting hole (60) vertically penetrating through the center of the upper surface of the arc inducing body (52).

The lifting bar (58) is disposed on the arc inducing body (52) to be movable up and down, and serves to move the arc inducing head (62), which will be described later, up and down.

At an upper end of the lifting bar (58), an arc inducing head (62) is fixedly disposed. The arc inducing head (62) is formed in a cylindrical shape and is formed of a conductive material. The arc inducing head (62) is fixedly disposed at an upper end of the lifting bar (58). The arc inducing head (62) is disposed to be vertically movable in the fixed contact (44) according to the vertical movement of the lifting bar (58). The arc inducing head (62) is disposed higher than the fixed contact (44). The arc inducing head (62) is disposed adjacent to the moving contact (30) before the fixed contact (44) when the moving contact (30) is adjacent to the fixed contact (44) for a ground operation. Accordingly, the arc inducing head (62) serves to induce an arc that may be generated at the moving contact (30) (See FIG. 4).

An elastic member (64) is disposed in the elastic member mounting groove (54). The elastic member (64) is a general spring, and a detailed description thereof will be omitted. One end of the elastic member (64) is in close contact with the bottom surface of the elastic member mounting groove (54), and the other end of the elastic member (64) is in close contact with the lower surface of the arc inducing head (62). The elastic member (64) is disposed at a lower portion of the arc inducing head (62) to elastically support the arc inducing head (62) in an upward direction.

That is, as the arc inducing head (62) is elastically supported by the elastic member (64), the moving contact (30) and the arc inducing head (62) may be kept in close contact with each other during the grounding operation, and the arc inducing head (62) may be moved downward. Accordingly, the fixed contact (44) arranged further below the arc inducing head (62) and the moving contact (30) may be grounded.

Hereinafter, the operation of the earth switching device according to the present disclosure will be described with reference to FIGS. 1 to 5.

First, the earth switching device is operated in a ground state and a short state. The ground state of the earth switching device is operated by the manipulator (14) according to a ground signal. In addition, according to the operation of the manipulator (14), the moving part (20) disposed to be able to reciprocate up and down with respect to the manipulator (14) linearly moves downward.

The moving part (20) gradually moves downward as shown in FIG. 4, and is adjacent to the arc inducing head (62) before the moving part (20) is grounded to the fixed contact (44). Accordingly, an arc generated from the moving contact (30) is induced to the arc inducing head (62).

When the moving contact (30) and the arc inducing head (62) are maintained in close contact with each other, and the moving contact (30) continues to move downward until it is finally grounded with the fixed contact (44), thereby completing the ground operation, as shown FIG. 3.

On the contrary, the short-circuit state of the earth switching device is operated by the manipulator (14) according to a short-circuit signal. According to the operation of the manipulator (14), the moving part (20) disposed to be able to reciprocate up and down with respect to the manipulator (14) linearly moves upward.

The moving part (20) gradually moves upward as shown in FIG. 5, and is short-circuited with the fixed contact (44). In this case, even if the moving contact (30) and the fixed contact (44) are short-circuited, the moving contact (30) and the arc inducing head (62) are maintained in close contact with each other.

That is, since the arc inducing head (62) is disposed higher than the fixed contact (44), the state in which the arc inducing head (62) is in close contact with the moving contact (30) may be maintained even after the fixed contact (44) and the moving contact (30) are short-circuited.

When the moving contact (30) is moved up to a predetermined distance or more, the moving contact (30) and the arc inducing head (62) are short-circuited. At the same time, the fluid (26) filled in the fluid receiving part (24) is sprayed in the downward direction to suppress the arc generated in the short circuit operation.

Therefore, in the earth switching device of the present disclosure, the arc inducing part (50) is provided in the fixed part (40) to induce an arc generated at the moving contact (30) toward the arc inducing part (50) when the moving contact (30) and the fixed contact (44) become close to or away from each other, thereby preventing damage to the fixed contact (44) by the arc.

In addition, since the arc inducing head (62) of the arc inducing part (50) is provided inside the fixed part to be movable up and down, the contact between the moving contact (30) and the arc inducing head (62) is maintained even after the moving contact (30) is short-circuited with the fixed contact (44), thereby minimizing the arc generated toward the fixed contact (44).

In addition, after the moving contact (30) and the arc inducing part (50) are short-circuited, the fluid (26) formed of the insulating gas is sprayed toward the arc inducing part (50) to suppress the generation of the arc, thereby minimizing damage to the moving contact (30) by the arc.

The scope of the present disclosure is not limited to the above-described embodiments, and many other modifications based on the present invention will be made to those skilled in the art within the technical scope as described above.

1. An earth switching device, comprising:
a housing;
a moving part which is provided inside the housing to be reciprocated by a manipulator and having a moving contact at an end thereof;
a fixed part disposed to be spaced apart from the moving part by a predetermined distance, and having a fixed contact selectively grounded or short-circuited with the moving contact according to the reciprocating motion of the moving part; and,
an arc inducing part provided to be able to move up and down inside the fixed contact, and inducing an arc generated at the moving contact when the moving contact approaches or moves away from the fixed contact.

2. The earth switching device of claim 1, wherein the arc inducing part is disposed to protrude further upward than the fixed contact.

3. The earth switching device of claim 1, wherein the arc inducing part is disposed to be elastically supported in the direction of the moving contact.

4. The earth switching device of claim 1, wherein the arc inducing part comprises:
an arc inducing body provided inside the fixed part and having an elastic member mounting groove formed on an upper surface thereof and a lifting bar guide groove formed on a lower surface thereof;
a lifting bar formed in a shape of a bar and provided inside the arc inducing body to be vertically movable along the lifting bar guide groove;
an arc inducing head fixedly provided at an end of the lifting bar and made of a conductive material to induce an arc when the moving contact is adjacent to the arc inducing head; and
an elastic member made of an elastic body, provided inside the elastic member mounting groove, and one end thereof is in close contact with one side of the arc inducing head to elastically support the arc inducing head.

5. The earth switching device of claim 1, wherein the moving part further includes a fluid receiving part formed as an empty space and is filled with a fluid therein.

6. The earth switching device of claim 5, wherein one side of the fluid receiving part includes a fluid injecting hole formed vertically through the moving part,
wherein one end of the fluid injecting hole communicates with the fluid receiving part, and the other end thereof communicates with the outside to spray the fluid onto the arc inducing part.

7. The earth switching device of claim 5, wherein the fluid filled in the fluid receiving part is sprayed to the arc inducing part when the fixed contact and the moving contact are away from each other.

8. The earth switching device of claim 7, wherein the fluid consists of an insulating gas and is sprayed onto a lower portion of the moving contact to suppress the generation of an arc.
